(19) United States
(12) Patent Application Publication
(10) Pub. No.: US 2024/0031505 A1
(43) Pub. Date: Jan. 25, 2024

(54) INFORMATION PROCESSING APPARATUS, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventor: Koji HAYASHI, Kanagawa (JP)

(73) Assignee: FUJIFILM Business Innovation Corp., Tokyo (JP)

(21) Appl. No.: 18/166,437

(22) Filed: Feb. 8, 2023

(30) Foreign Application Priority Data
Jul. 19, 2022 (JP) 2022-115108

(51) Int. Cl. H04N 1/327; H04N 1/00

(52) U.S. Cl. CPC H04N 1/3275; H04N 1/00228

(57) ABSTRACT

An information processing apparatus includes: a processor configured to: acquire characteristic information related to a characteristic of each destination information together with an address table including plural destination information from another apparatus; and register, in a case where the number of cases of the destination information included in the acquired address table is larger than the number of cases of destination information that is registrable in an address table of the information processing apparatus, a part of the destination information included in the acquired address table in the address table of the information processing apparatus, by using the characteristic information.

### CROSS-REFERENCE TO RELATED APPLICATIONS

This application is based on and claims priority under 35 USC 119 from Japanese Patent Application No. 2022-115108 filed Jul. 19, 2022.

### BACKGROUND

### (i) Technical Field

The present invention relates to an information processing apparatus, a non-transitory computer readable medium storing a program, and an information processing method.

### (ii) Related Art

JP2003-087539A describes a data communication apparatus that exports only destination information that is usable by another data communication apparatus of an import destination and efficiently imports the destination information.

JP6327894B describes a processing apparatus that prevents a loss of meaningful address information when an address book having a large number of registered address information is distributed to an address book of a different model having a small number of registered address information.

### SUMMARY

In an information processing apparatus such as a multifunction machine, destination information included in an address table acquired from an external apparatus is registered in an address table of the information processing apparatus, in some cases.

Meanwhile, in a case where the number of cases of destination information included in the acquired address table is larger than the number of cases of destination information that is registrable in the address table of the information processing apparatus, a user manually selects destination information to be registered in the address table of the information processing apparatus, which is troublesome.

Aspects of non-limiting embodiments of the present disclosure relate to an information processing apparatus, a non-transitory computer readable medium storing a program, and an information processing method that registers, even in a case where the number of destination information included in an address table acquired from another apparatus is larger than the number of cases of destination information that is registrable in an address table of the information processing apparatus, the destination information included in the acquired address table in the address table of the information processing apparatus, without requiring any operation by a user.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including: a processor configured to: acquire characteristic information related to a characteristic of each destination information together with an address table including a plurality of destination information from another apparatus; and register, in a case where the number of cases of the destination information included in the acquired address table is larger than the number of cases of destination information that is registrable in an address table of the information processing apparatus, a part of the destination information included in the acquired address table in the address table of the information processing apparatus, by using the characteristic information.

### BRIEF DESCRIPTION OF THE DRAWINGS

Exemplary embodiment(s) of the present invention will be described in detail based on the following figures, wherein:

FIG. 1 is a diagram illustrating a system configuration of an image forming system according to an exemplary embodiment of the present invention;

FIG. 2 is a block diagram illustrating a hardware configuration of an image forming apparatus 10A;

FIG. 3 is a block diagram illustrating a functional configuration of the image forming apparatus 10A;

FIG. 4 is a diagram illustrating an example of an address table registered in an image forming apparatus 10B;

FIG. 5 is a diagram illustrating an example of a table for setting a priority of each destination information included in the acquired address table;

FIG. 6 is a diagram illustrating a special rule in a case where the acquired address table is registered in the image forming apparatus 10A;

FIG. 7 is a diagram illustrating a result of setting a priority of each destination information included in the acquired address table;

FIG. 8 is a diagram illustrating an example of the address table registered in the image forming apparatus 10A;

FIG. 9 is a first half of a flowchart illustrating a flow of a process in a case where an address table acquired from the image forming apparatus 10B is registered in the image forming apparatus 10A;

FIG. 10 is a second half of the flowchart illustrating the flow of the process in a case where the address table acquired from the image forming apparatus 10B is registered in the image forming apparatus 10A; and

FIG. 11 is a diagram illustrating another example of the address table registered in the image forming apparatus 10B.

### DETAILED DESCRIPTION

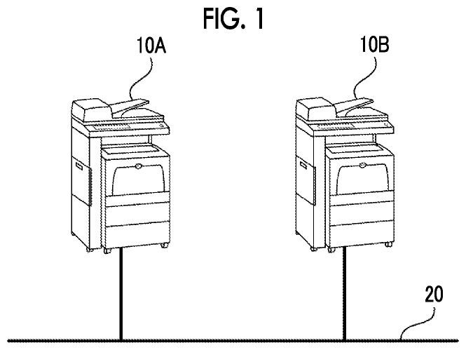

Hereinafter, exemplary embodiments of the present invention will be described in detail with reference to the accompanying drawings. FIG. 1 is a diagram illustrating a system configuration of an image forming system according to an exemplary embodiment of the present invention.

As illustrated in FIG. 1, the image forming system of the present exemplary embodiment is configured with an image forming apparatus 10A, and an image forming apparatus 10B connected to each other by a network 20.

The image forming apparatus 10A, and the image forming apparatus 10B are all so-called multifunction machines having a plurality of functions such as a print function, a scanning function, a copying function, and a facsimile function.

Both the image forming apparatus 10A and the image forming apparatus 10B are configured such that an address table including a plurality of destination information can be registered in the apparatus.

In addition, the image forming apparatus 10A can register an address table acquired from the image forming apparatus 10B in the image forming apparatus 10A. The image forming apparatus 10A is an example of an information processing apparatus according to a technology of the exemplary embodiment of the present invention.

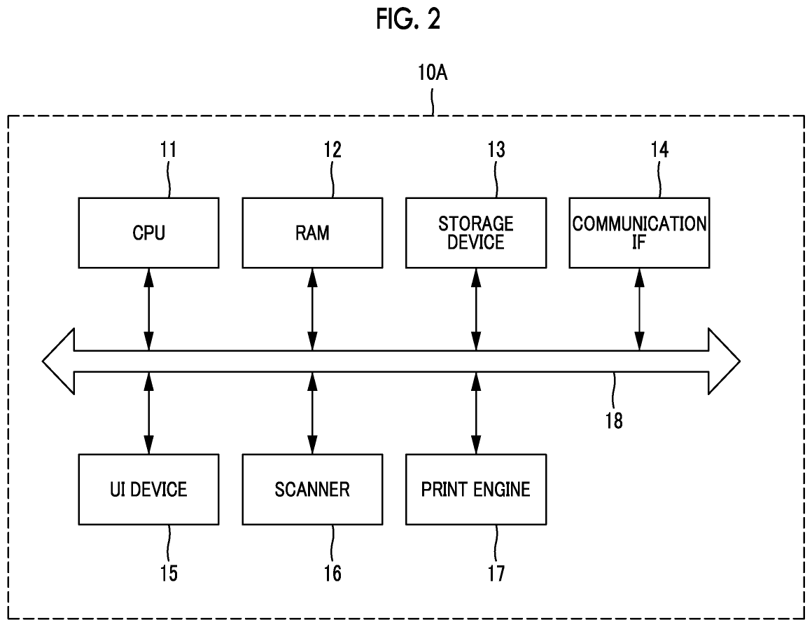

Next, a hardware configuration of the image forming apparatus 10A of the present exemplary embodiment will be described. FIG. 2 is a block diagram illustrating a hardware configuration of the image forming apparatus 10A.

As illustrated in FIG. 2, the image forming apparatus 10A includes a central processing unit (CPU) 11, a random access memory (RAM) 12, a storage device 13 such as a hard disk drive, a communication interface (abbreviated as IF) 14, a user interface (abbreviated as UI) device 15 including a touch panel or a liquid crystal display, and a keyboard, a scanner 16, and a print engine 17. These components are connected to each other via a control bus 18.

The communication IF 14 transmits and receives data to and from an external apparatus or the like via the network 20. The UI device 15 accepts an instruction input from a user. The scanner 16 scans a document loaded in the image forming apparatus 10A as image data. The print engine 17 prints an image on a recording medium such as printing paper through steps such as charging, exposure, development, transfer, and fixing.

The CPU 11 is a processor that controls an operation of the image forming apparatus 10A by executing a predetermined process based on a control program stored in the RAM 12 or the storage device 13. In the present exemplary embodiment, the CPU 11 is described as the processor reading and executing the control program stored in the RAM 12 or the storage device 13, and the present exemplary embodiment is not limited thereto. The control program may be provided in a form recorded on a computer-readable recording medium. For example, this program may be provided as a form recorded on an optical disk such as a compact disc (CD)-read only memory (ROM) and a digital versatile disc (DVD)-ROM, or a semiconductor memory such as a universal serial bus (USB) memory and a memory card. Further, the control program may be acquired from an external apparatus via a communication line connected to the communication interface 14.

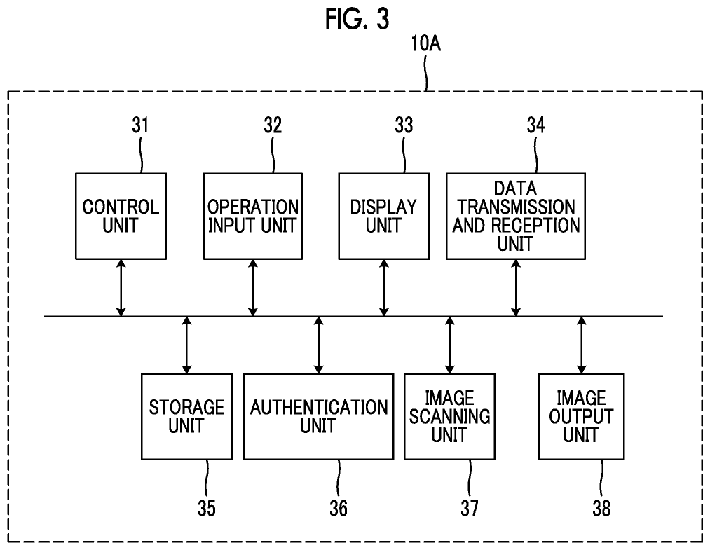

Next, a functional configuration of the image forming apparatus 10A of the present exemplary embodiment will be described. FIG. 3 is a block diagram illustrating the functional configuration of the image forming apparatus 10A.

As illustrated in FIG. 3, the image forming apparatus 10A of the present exemplary embodiment includes a control unit 31, an operation input unit 32, a display unit 33, a data transmission and reception unit 34, a storage unit 35, an authentication unit 36, an image scanning unit 37, and an image output unit 38.

The control unit 31 controls an overall operation of the image forming apparatus 10A, and performs control of scanning a document image by the image scanning unit 37 based on the instruction input from the user, control of outputting print data from the image output unit 38, and the like.

The operation input unit 32 inputs information on various operations performed by the user. The display unit 33 is controlled by the control unit 31, and displays various types of information to the user. The data transmission and reception unit 34 transmits and receives data to and from an external apparatus such as the image forming apparatus 10B.

The storage unit 35 stores data such as an address table in addition to the control program. The address table will be described in detail below. The authentication unit 36 executes an authentication process for the user who intends to use the image forming apparatus

The image scanning unit 37 scans a document image from a loaded document, based on the control by the control unit 31. The image output unit 38 outputs an image on a recording medium such as printing paper based on the control by the control unit 31.

The image forming apparatus 10A of the present exemplary embodiment can register an address table acquired from an external apparatus such as the image forming apparatus 10B in the image forming apparatus 10A. Meanwhile, in a case where the number of destination information included in the acquired address table is larger than the number of cases of destination information that is registrable in an address table of the image forming apparatus 10A, the acquired address table as it is cannot be registered in the image forming apparatus 10A.

The address table is a table in which a “registration number” and “destination information” are recorded in association with each other. The “registration number” is a number assigned in ascending order from “1”. The “destination information” includes, for example, information such as a “destination name”, a “destination type”, and a “number/address”. The contents of the address table will be described in detail below.

Therefore, the control unit 31 acquires characteristic information related to a characteristic of each destination information together with the address table including the plurality of destination information, and registers a part of the destination information included in the acquired address table in the address table of the image forming apparatus 10A by using the characteristic information in a case where the number of cases of destination information included in the obtained address table is larger than the number of cases of destination information that is registrable in the address table of the image forming apparatus 10A.

Regarding the characteristic information, a part of information included in the address table may be used as the characteristic information, information acquired separately from the address table may be used as the characteristic information, or both the pieces of information may be used.

In the image forming apparatus 10A of the present exemplary embodiment, the characteristic information may include information related to a destination type of each destination information, and the control unit 31 may preferentially register destination information having a high priority set according to the destination type, in the address table of in the image forming apparatus 10A.

In addition, the characteristic information may include information related to a use count of each destination information, and the control unit 31 may preferentially register destination information having a high priority set according to a combination of the destination type and the use count, in the address table of the image forming apparatus 10A.

In a case where the same registration number of the destination information to be registered in the address table of the image forming apparatus 10A as a registration number in the acquired address table is unregistered in the address table of the image forming apparatus 10A, the control unit 31 may register this destination information in the same registration number as the registration number in the address table from which the destination information is acquired.

Further, in a case where the same registration number of the destination information to be registered in the address table of the image forming apparatus 10A as the registration number in the acquired address table is already registered in the address table of the image forming apparatus 10A, the control unit 31 may register this destination information in a registration number at the foremost head among unregistered registration numbers in the address table of the image forming apparatus 10A.

Further, in a case where the same registration number of the destination information to be registered in the address table of the image forming apparatus 10A as the registration number in the acquired address table is already registered in the address table of the image forming apparatus 10A, the control unit 31 may not this destination information in the address table of the image forming apparatus 10A.

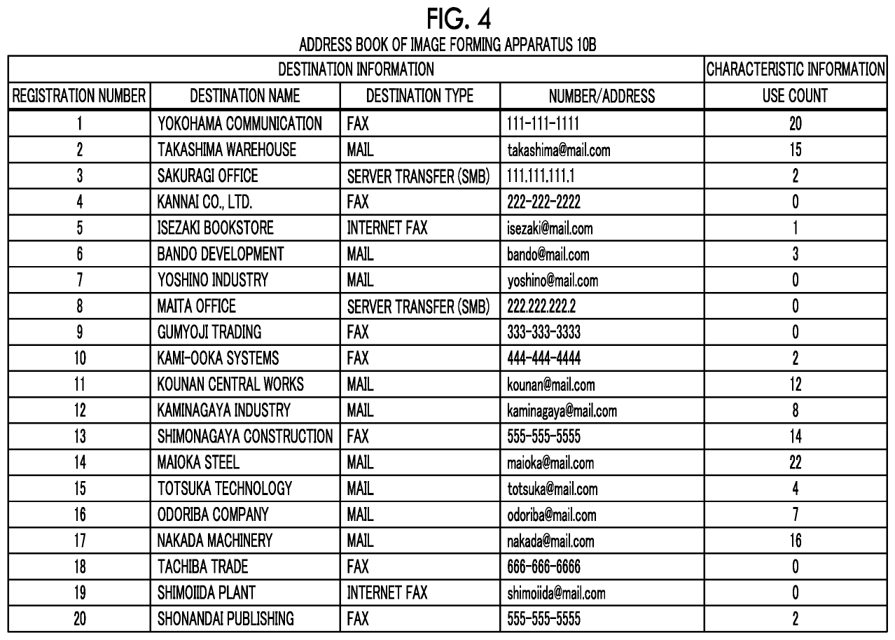

Hereinafter, a process in the image forming apparatus 10A of the present exemplary embodiment will be described in detail. First, an address table managed by the image forming apparatus 10A and the image forming apparatus 10B will be described. FIG. 4 is a diagram illustrating an example of an address table registered in the image forming apparatus 10B.

As illustrated in FIG. 4, information such as a “registration number”, a “destination name”, a “destination type”, and a “number/address” is managed in the address table. The “registration number” is information indicating a registration number of destination information in the image forming apparatus 10B. The “destination name” is information indicating a name of a destination. The “destination type” is information indicating communication means such as, for example, mail, fax, or Internet fax. The information of the “destination type” is an example of characteristic information in the technology of the exemplary embodiment of the present invention. The “number/address” is, for example, information for specifying a communication destination in the communication means indicated by the destination type, such as a telephone number, a fax number, or an e-mail address. As an example, 20 pieces of destination information are registered in the address table of the image forming apparatus 10B.

Further, in the image forming apparatus 10B, information of a “use count” for each destination information is managed. The information of “use count” is an example of characteristic information in the technology of the exemplary embodiment of the present invention. The “use count” is, as an example, information indicating the number of times of being used in the past year. The use count is not limited to the number of times of being used in the past year, and may have any mode such as the number of times of being used in the past six months or a total of the numbers of times of being used so far without setting a period.

Information managed in an address table of the image forming apparatus 10A has the same manner as the information managed in the address table of the image forming apparatus 10B. Meanwhile, in the address table of the image forming apparatus 10A, as an example, it is assumed that only 10 pieces of destination information can be registered.

Next, regarding the image forming apparatus 10A, a process of registering an address table acquired from the image forming apparatus 10B in the image forming apparatus 10A will be described.

In a case where the address table acquired from the image forming apparatus 10B is registered in the image forming apparatus 10A, the control unit 31 acquires information on a “use count” together with the address table from the image forming apparatus 10B, and performs the process according to the following basic rule, special rule 1, and special rule 2.

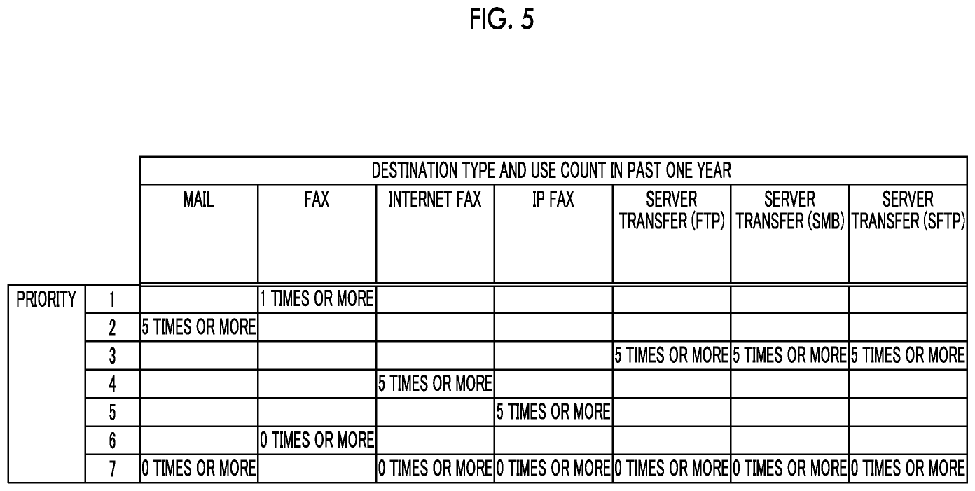

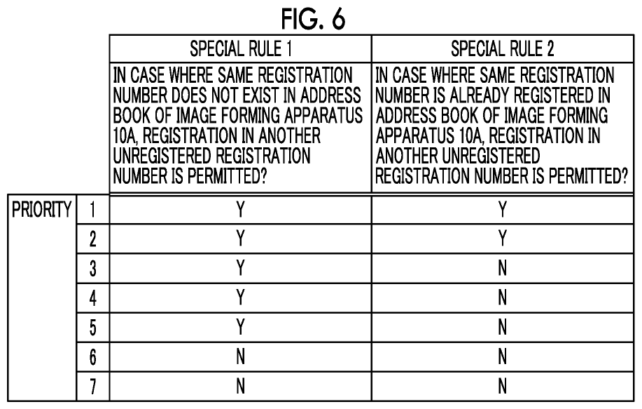

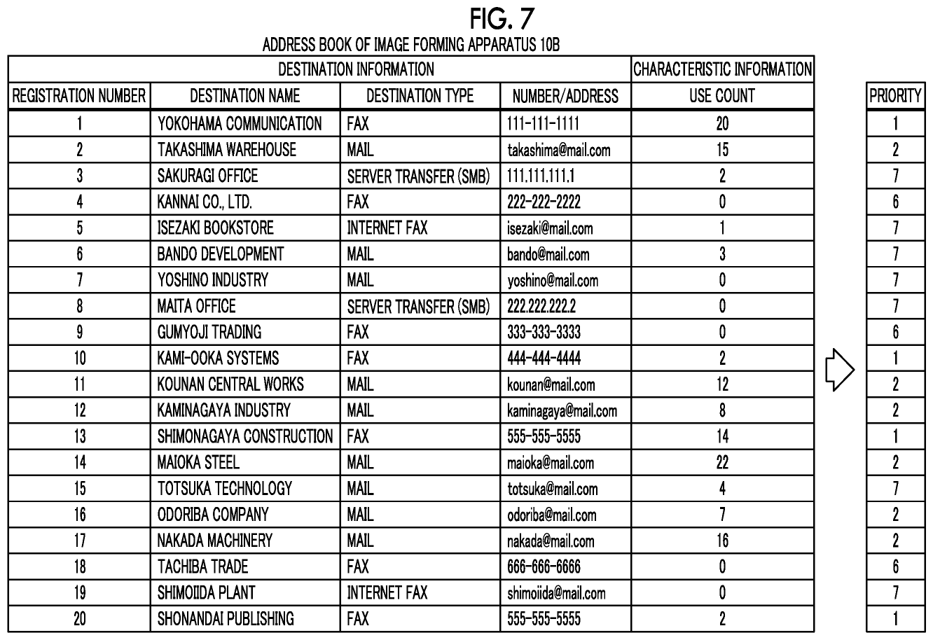

FIG. 5 is a diagram illustrating an example of a table for setting a priority of each destination information included in the acquired address table. FIG. 6 is a diagram describing a special rule for registering the acquired address table in the image forming apparatus 10A. FIG. 7 is a diagram illustrating a result of setting the priority of each destination information included in the acquired address table.

The basic rule is as follows. As illustrated in FIG. 5, the control unit 31 sets a priority for each destination information included in the acquired address table according to a table for setting the priority of each destination information included in the acquired address table, and registers the destination information in an address table of the image forming apparatus 10A in descending order of priority. At this time, the control unit 31 registers each destination information in the same registration number as a registration number in the acquired address table.

The table for setting the priority is a table that defines a relationship between a destination type, a use count, and a priority of the destination information. This table is stored in the storage unit 35. The contents of the table will be described in detail below.

Meanwhile, in a case where the same registration number as the registration number in the acquired address table of the destination information to be registered in the address table of the image forming apparatus 10A does not exist in the address table of the image forming apparatus 10A or is already registered, the process is performed according to the following special rule 1 and special rule 2.

The special rule 1 is as follows. As illustrated in FIG. 6, in a case where the same registration number of the destination information to be registered in the address table of the image forming apparatus 10A as the registration number in the acquired address table does not exist in the address table of the image forming apparatus 10A, the control unit 31 permits only destination information with a numerical value of a priority equal to or less than 5 to be registered in another unregistered registration number in the address table of the image forming apparatus 10A. The control unit 31 registers the destination information for which registration is permitted, in a registration number at the foremost head among the unregistered registration numbers in the address table of the image forming apparatus 10A.

The special rule 2 is as follows. As illustrated in FIG. 6, in a case where the same registration number of the destination information to be registered in the address table of the image forming apparatus 10A as the registration number in the acquired address table is already registered in the address table of the image forming apparatus 10A, the control unit 31 permits only destination information with a numerical value of a priority equal to or less than 2 to be registered in another unregistered registration number in the address table of the image forming apparatus 10A. The control unit 31 registers the destination information for which registration is permitted, in a registration number at the foremost head among the unregistered registration numbers in the address table of the image forming apparatus 10A.

First, the control unit 31 refers to a table for setting a priority, and uses information of a “destination type” and information of a “use count” in the address table acquired from the image forming apparatus 10B to set the priority to each destination information. Here, it is assumed that a priority 1 is the highest priority, and the higher the numerical value of the priority, the lower the priority.

In the present exemplary embodiment, the priority of the destination information with the destination type of a mail is set to 2 in a case where the use count in the past year is equal to or more than 5, and set to 7 in a case where the use count in the past year is equal to or less than 4.

Further, the priority of the destination information with the destination type of a fax is set to 1 in a case where the use count in the past year is equal to or more than 1, and set to 6 in a case where the use count in the past year is 0.

Further, the priority of the destination information with the destination type of an Internet fax is set to 4 in a case where the use count in the past year is equal to or more than 5, and set to 7 in a case where the use count in the past year is equal to or less than 4.

Further, the priority of the destination information with the destination type of an IP fax is set to 5 in a case where the use count in the past year is equal to or more than 5, and set to 7 in a case where the use count in the past year is equal to or less than 4.

Further, the priority of the destination information with the destination type of server transfer is set to 3 in a case where the use count in the past year is equal to or more than 5, and set to 7 in a case where the use count in the past year is equal to or less than 4.

In the table for setting the priority, the fax has the highest priority since transmission cannot be performed by using another device such as a personal computer or a mobile terminal, like another destination type such as the mail or the server transfer.

Further, since the server transfer is generally used for data transfer within a company rather than for a customer, the priority is set lower than the fax or the mail. In addition, since a use rate of the Internet fax is low, the priority of the Internet fax is set lower than the priority of the server transfer.

As described above, a result of setting the priority for each destination information included in the address table of the image forming apparatus 10B is as illustrated in FIG. 7.

A priority is set to 1 for destination information of registration numbers 1, 10, 13, and with which a destination type is a fax and a use count in the past year is equal to or more than 1.

In addition, the priority is set to 2 for destination information of registration numbers 2, 11, 12, 14, 16, and 17 with which a destination type is a mail and the use count in the past year is equal to or more than 5.

In addition, the priority is set to 6 for destination information of registration numbers 4, 9, and 18 with which the destination type is a fax and the use count in the past year is 0.

The priority is set to 7 for destination information of registration numbers other than the registration numbers described above.

Next, in a case where the address table of the image forming apparatus 10B including 20 pieces of destination information is registered in an address table of the image forming apparatus 10A in which only 10 pieces of destination information can be registered, the control unit 31 registers the address table of the image forming apparatus 10B in the address table of the image forming apparatus 10A in descending order of priority set in each destination information included in the address table of the image forming apparatus 10B, according to the basic rule.

At this time, in a case where the same registration number as the registration number in the acquired address table of the destination information to be registered in the address table of the image forming apparatus 10A does not exist in the address table of the image forming apparatus 10A or is already registered, the process is performed according to the special rule 1 and special rule 2.

Here, in a state where no destination information is registered in the address table of the image forming apparatus 10A, the destination information included in the address table of the image forming apparatus 10B is registered in the address table of the image forming apparatus 10A.

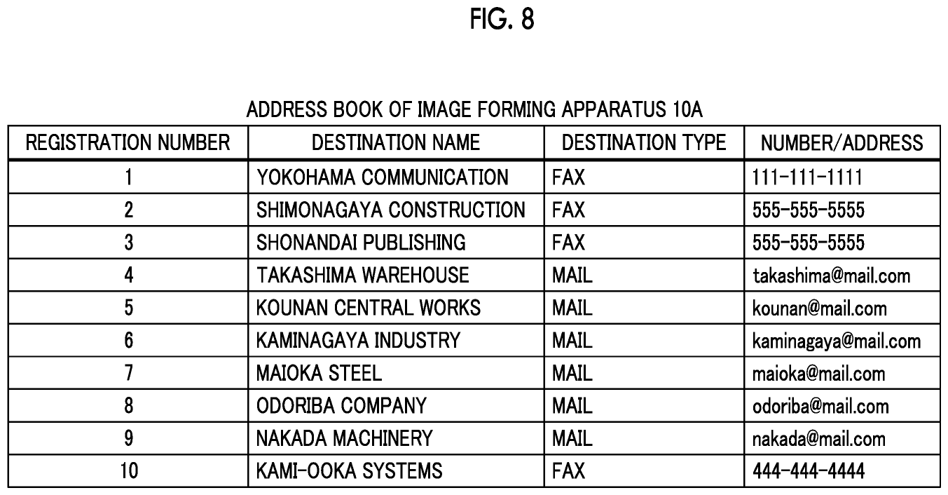

FIG. 8 is a diagram illustrating an example of an address table registered in the image forming apparatus 10A. As illustrated in FIG. 8, the control unit 31 registers an address table of the image forming apparatus 10B in the address table of the image forming apparatus 10A, in order from destination information having the highest priority and the smallest registration number.

First, in the address table of the image forming apparatus 10B, destination information having a priority of 1, that is, a destination type of a fax and a use count in the past year equal to or more than 1 will be described.

Destination information of “Yokohama Communication” having a registration number 1 in the address table of the image forming apparatus 10B is registered in the same registration number 1 in the address table of the image forming apparatus 10A.

Further, destination information of “Kami-Ooka Systems” having a registration number 10 in the address table of the image forming apparatus 10B is registered in the same registration number 10 in the address table of the image forming apparatus 10A.

Further, destination information of “Shimonagaya Construction” having a registration number 13 in the address table of the image forming apparatus 10B is registered in a registration number 2 at the foremost head of unregistered registration numbers since the same registration number does not exist in the address table of the image forming apparatus 10A.

Further, destination information of “Shonandai Publishing” having a registration number 20 in the address table of the image forming apparatus 10B is registered in a registration number 3 at the foremost head of unregistered registration numbers since the same registration number does not exist in the address table of the image forming apparatus 10A.

Next, in the address table of the image forming apparatus 10B, destination information having a priority of 2, that is, a destination type of a mail and a use count in the past year equal to or more than 5 will be described.

Destination information of “Takashima Warehouse” having a registration number 2 in the address table of the image forming apparatus 10B is registered in a registration number 4 at the foremost head of unregistered registration numbers since the same registration number does not exist in the address table of the image forming apparatus 10A.

Further, destination information of “Kounan Central Works” having a registration number 11 in the address table of the image forming apparatus 10B is registered in a registration number 5 at the foremost head of unregistered registration numbers since the same registration number does not exist in the address table of the image forming apparatus 10A.

Further, destination information of “Kaminagaya Industry” having a registration number 12 in the address table of the image forming apparatus 10B is registered in a registration number 6 at the foremost head of unregistered registration numbers since the same registration number does not exist in the address table of the image forming apparatus 10A.

Further, destination information of “Maioka Steel” having a registration number 14 in the address table of the image forming apparatus 10B is registered in a registration number 7 at the foremost head of unregistered registration numbers since the same registration number does not exist in the address table of the image forming apparatus 10A.

Further, destination information of “Odoriba Company” having a registration number 16 in the address table of the image forming apparatus 10B is registered in a registration number 8 at the foremost head of unregistered registration numbers since the same registration number does not exist in the address table of the image forming apparatus 10A.

Further, destination information of “Nakada Machinery” having a registration number 17 in the address table of the image forming apparatus 10B is registered in a registration number 9 at the foremost head of unregistered registration numbers since the same registration number does not exist in the address table of the image forming apparatus 10A.

At the stage of registration up to this point, since an upper limit of the number of cases that is registrable in the address table of the image forming apparatus 10A is reached, the registration process is stopped.

With the above process, even in a case where the number of destination information included in the acquired address table is larger than the number of cases that is registrable as the destination information of the address table of the image forming apparatus 10A, the destination information included in the acquired address table is registered in the address table of the image forming apparatus 10A, without requiring an operation by the user.

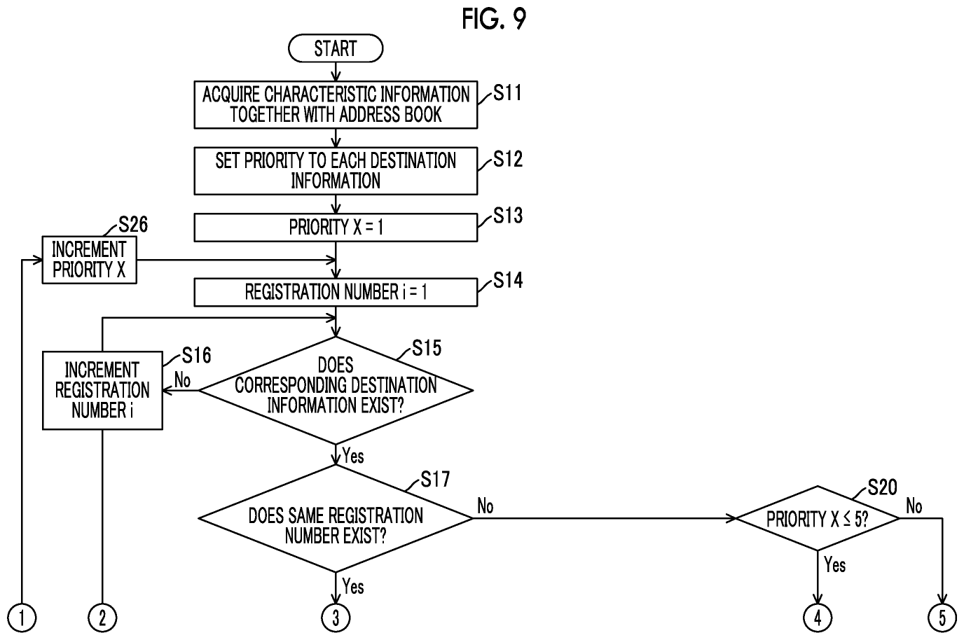

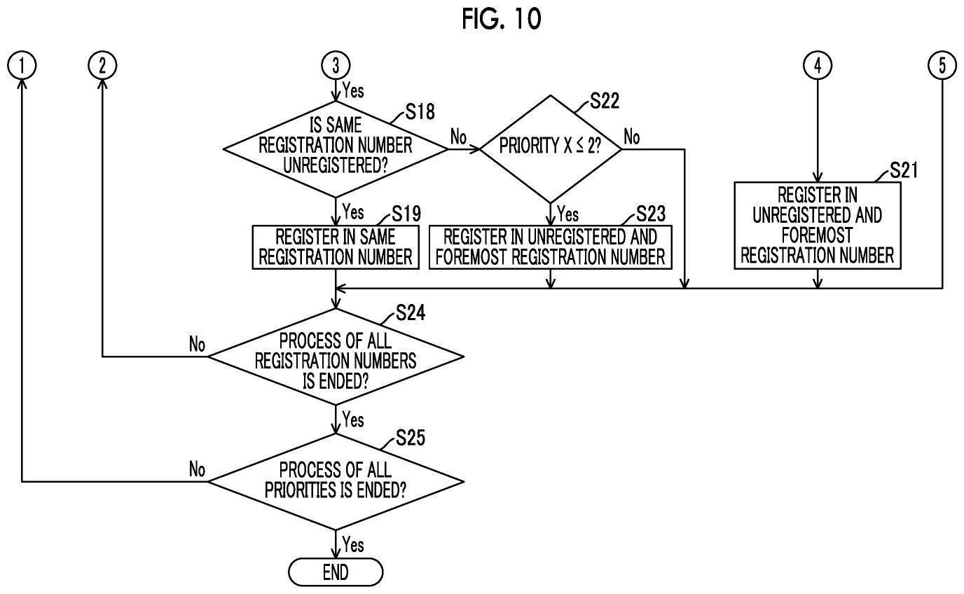

Next, a process in the image forming apparatus 10A of registering the address table acquired from the image forming apparatus 10B will be described with reference to flowcharts in FIGS. 9 and 10. The flowcharts in FIGS. 9 and 10 illustrate a series of flowcharts divided into a first half and a second half

First, in step S11, the control unit 31 of the image forming apparatus 10A acquires characteristic information together with an address table from the image forming apparatus 10B.

Next, in step S12, the control unit 31 sets a priority for each of a plurality of destination information included in the acquired address table according to the table in FIG. 5.

Next, in step S13, the control unit 31 sets a priority X to 1 as information for specifying destination information as a target of the registration process, among the pieces of destination information included in the acquired address table.

Next, in step S14, the control unit 31 sets a registration number i to 1 as the information for specifying the destination information as the target of the registration process, among the pieces of destination information included in the acquired address table.

Next, in step S15, the control unit 31 determines whether or not destination information corresponding to the set priority X and the registration number i exists.

In step S15, in a case where it is determined that the corresponding destination information does not exist, the control unit 31 increments the registration number i in step S16 and then proceeds to step S15.

In step S15, in a case where it is determined that the corresponding destination information exists, the control unit 31 determines whether or not the same registration number as the registration number of the destination information during the registration process exists in an address table of the image forming apparatus 10A in step S17.

In step S17, in a case where it is determined in step S17 that the same registration number as the registration number of the destination information during the registration process exists in the address table of the image forming apparatus 10A, the control unit 31 determines whether or not the same registration number as the registration number of the destination information during the registration process is unregistered in the address table of the image forming apparatus 10A in step S18.

In step S18, in a case where the same registration number as the registration number of the destination information during the registration process is determined to be unregistered in the address table of the image forming apparatus, in step S19, the control unit 31 registers the destination information during the registration process in the address table of the image forming apparatus 10A with the same registration number as the registration number of the destination information during the registration process, and then proceeds to step S24.

In step S17, in a case where it is determined that the same registration number as the registration number of the destination information during the registration process does not exist in the address table of the image forming apparatus 10A, the control unit 31 determines whether or not the priority X of the destination information during the registration process is equal to or less than 5, in step S20.

In step S20, in a case where it is determined that the priority X of the destination information during the registration process is equal to or less than 5, the control unit 31 registers the destination information during the registration process with a registration number at the foremost head among unregistered registration numbers in the address table of the image forming apparatus 10A in step S21, and then proceeds to step S24.

In step S20, in a case where it is determined that the priority X of the destination information during the registration process is not equal to or less than 5, the control unit 31 does not register the destination information during the registration process in the address table of the image forming apparatus 10A, and then proceeds to S24.

Further, in step S18, in a case where it is determined that the same registration number as the registration number of the destination information during the registration process is not unregistered in the address table of the image forming apparatus 10A, that is, is already registered, the control unit 31 determines whether or not the priority X of the destination information during the registration process is equal to or less than 2, in step S22.

In step S22, in a case where it is determined that the priority X of the destination information during the registration process is equal to or less than 2, the control unit 31 registers the destination information during the registration process with a registration number at the foremost head among unregistered registration numbers in the address table of the image forming apparatus 10A in step S23, and then proceeds to step S24.

In step S22, in a case where it is determined that the priority X of the destination information during the registration process is not equal to or less than 2, the control unit 31 does not register the destination information during the registration process in the address table of the image forming apparatus 10A, and then proceeds to S24.

Next, in step S24, the control unit 31 determines whether or not the process of all the registration numbers in the address table acquired from the image forming apparatus 10B is ended.

In step S24, in a case where it is determined that the process of all the registration numbers is not ended, the control unit 31 increments the registration number i in step S16, and then proceeds to step S15.

In a case where it is determined in step S24 that the process of all the registration numbers is ended, the control unit 31 determines whether or not the process of all the priorities in the address table acquired from the image forming apparatus 10B is ended in step S25.

In a case where it is determined in step S25 that the process of all the priorities is not ended, the control unit 31 increments the priority X in step S26, and then proceeds to step S14.

In step S25, in a case where it is determined that the process of all the priorities is ended, the control unit 31 ends the process.

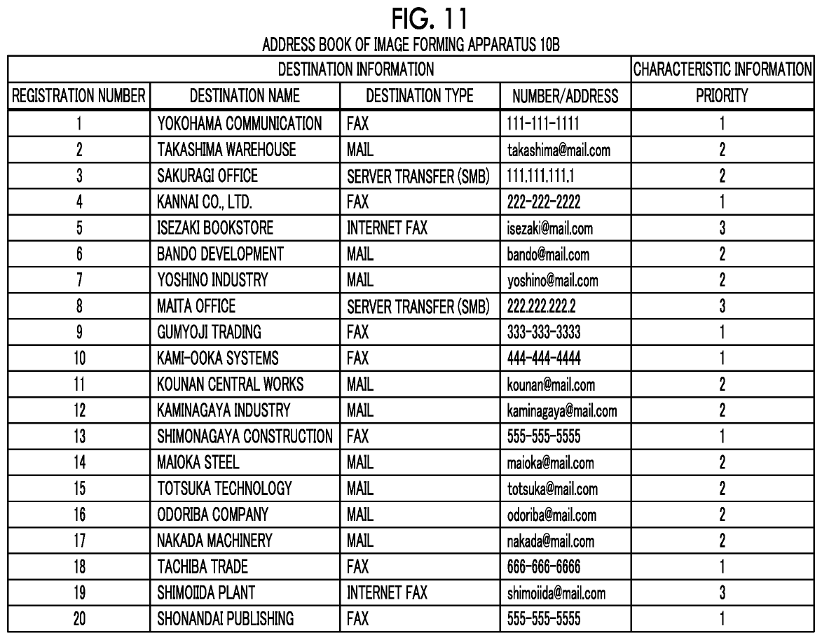

In the present exemplary embodiment, the control unit 31 of the image forming apparatus 10A acquires the information of the “destination type” and the “use count” as the characteristic information, and the exemplary embodiment is not limited to such an aspect. As illustrated in FIG. 11, the information of the “priority” set for each destination information may be acquired.

This “priority” may be arbitrarily set by the user in the image forming apparatus 10B, or may be automatically set by the control unit of the image forming apparatus 10B according to a preset method.

### Modification Example

Although the image forming system according to one exemplary embodiment of the present invention is described above, the present invention is not limited to the exemplary embodiment described above and can be modified as appropriate.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Further, in the above-described exemplary embodiment, the case where the exemplary embodiment of the present invention is applied to the image forming apparatus is described. Meanwhile, the exemplary embodiment of the present invention is not limited thereto, and the exemplary embodiment also can be applied to various types of information processing apparatuses such as a mobile phone, a tablet, a personal computer, and the like.

### Supplementary Note

Hereinafter, the exemplary embodiments according to the present disclosure will be described.

(((1)))

An information processing apparatus comprising:

a processor configured to:
acquire characteristic information related to a characteristic of each destination information together with an address table including a plurality of destination information from another apparatus; and
   register, in a case where the number of cases of the destination information included in the acquired address table is larger than the number of cases of destination information that is registrable in an address table of the information processing apparatus, a part of the destination information included in the acquired address table in the address table of the information processing apparatus, by using the characteristic information.

(((2)))

The information processing apparatus according to (((1))),
wherein the characteristic information includes information related to a destination type of each destination information, and
the processor is configured to:
   preferentially register destination information having a high priority set according to the destination type, in the address table of the information processing apparatus.

(((3)))

The information processing apparatus according to (((1))),
wherein the characteristic information includes information related to a use count of each destination information, and
the processor is configured to:
   preferentially register destination information having a high priority set according to a combination of the destination type and the use count, in the address table of the information processing apparatus.

(((4)))

The information processing apparatus according to any one of (((1))) to (((3))), wherein the processor is configured to:
register, in a case where a registration number, of destination information to be registered in the address table of the information processing apparatus, which is the same as a registration number in the acquired address table, is unregistered in the address table of the information processing apparatus, the destination information in the registration number which is the same as the registration number in the address table from which the destination information is acquired.

(((5)))

The information processing apparatus according to (((4))), wherein the processor is configured to:
register, in a case where the registration number, of the destination information to be registered in the address table of the information processing apparatus, which is the same as the registration number in the acquired address table, is already registered in the address table of the information processing apparatus, the destination information in a registration number at a foremost head among unregistered registration numbers in the address table of the information processing apparatus.

(((6)))

The information processing apparatus according to (((4))), wherein the processor is configured not to:
register, in a case where the registration number, of the destination information to be registered in the address table of the information processing apparatus, which is the same as the registration number in the acquired address table, is already registered in the address table of the information processing apparatus, the destination information in the address table of the information processing apparatus.

(((7)))

A non-transitory computer readable medium storing a program causing a computer to execute a process comprising:
acquiring characteristic information related to a characteristic of each destination information together with an address table including a plurality of destination information from another apparatus; and
registering, in a case where the number of cases of the destination information included in the acquired address table is larger than the number of cases of destination information that is registrable in an address table of the information processing apparatus, a part of the destination information included in the acquired address table in the address table of the information processing apparatus, by using the characteristic information.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
acquire characteristic information related to a characteristic of each destination information together with an address table including a plurality of destination information from another apparatus; and
register, in a case where the number of cases of the destination information included in the acquired address table is larger than the number of cases of destination information that is registrable in an address table of the information processing apparatus, a part of the destination information included in the acquired address table in the address table of the information processing apparatus, by using the characteristic information.

2. The information processing apparatus according to claim 1,
wherein the characteristic information includes information related to a destination type of each destination information, and
the processor is configured to:
preferentially register destination information having a high priority set according to the destination type, in the address table of the information processing apparatus.

3. The information processing apparatus according to claim 2,
wherein the characteristic information includes information related to a use count of each destination information, and
the processor is configured to:
preferentially register destination information having a high priority set according to a combination of the destination type and the use count, in the address table of the information processing apparatus.

4. The information processing apparatus according to claim 1, wherein the processor is configured to:
register, in a case where a registration number, of destination information to be registered in the address table of the information processing apparatus, which is the same as a registration number in the acquired address table, is unregistered in the address table of the information processing apparatus, the destination information in the registration number which is the same as the registration number in the address table from which the destination information is acquired.

5. The information processing apparatus according to claim 4, wherein the processor is configured to:
register, in a case where the registration number, of the destination information to be registered in the address table of the information processing apparatus, which is the same as the
registration number in the acquired address table, is already registered in the address table of the information processing apparatus, the destination information in a registration number at a foremost head among unregistered registration numbers in the address table of the information processing apparatus.

6. The information processing apparatus according to claim 4, wherein the processor is configured not to:
register, in a case where the registration number, of the destination information to be registered in the address table of the information processing apparatus, which is the same as the registration number in the acquired address table, is already registered in the address table of the information processing apparatus, the destination information in the address table of the information processing apparatus.

7. A non-transitory computer readable medium storing a program causing a computer to execute a process comprising:
acquiring characteristic information related to a characteristic of each destination information together with an address table including a plurality of destination information from another apparatus; and
registering, in a case where the number of cases of the destination information included in the acquired address table is larger than the number of cases of destination information that is registrable in an address table of the information processing apparatus, a part of the destination information included in the acquired address table in the address table of the information processing apparatus, by using the characteristic information.

8. An information processing method comprising:
acquiring characteristic information related to a characteristic of each destination information together with an address table including a plurality of destination information from another apparatus; and
registering, in a case where the number of cases of the destination information included in the acquired address table is larger than the number of cases of destination information that is registrable in an address table of the information processing apparatus, a part of the destination information included in the acquired address table in the address table of the information processing apparatus, by using the characteristic information.
